(19) United States
(12) Patent Application Publication
(10) Pub. No.: US 2005/0027580 A1
(43) Pub. Date: Feb. 3, 2005

(54) Internet-based appointment scheduling system

(76) Inventors: Richard Crici, Lynbrook, NY (US); Raphael Sidelman, Woodmere, NY (US)

Correspondence Address: Galgano & Burke, Suite 35, 300 Rabro Drive, Hauppauge, NY, 11788, US

(21) Appl. No.: 10/731,195

(22) Filed: Dec. 8, 2003

Related U.S. Application Data
(63) Continuation of application No. 09/452,573, filed on Dec. 1, 1999, now abandoned.

(51) Int. Cl. G06F 17/60

(52) U.S. Cl. 705/8

(57) ABSTRACT

Appointment scheduling systems and methods of providing service receivers with remote appointment scheduling capabilities utilizing the Internet. According to one embodiment, at least one service provider, such as a physician, enters a schedule into a computer system showing time slots in which the physician will see patients. This system is linked to the Internet where it is available for viewing by the general public. When a member of the general public accesses the scheduling system, the potential service receiver can view the entire schedule and make appointments. The appointment schedule of the service provider is modified and most preferably, the appointment schedule of the service receiver is also modified. The scheduling system can also maintain the schedule of the service receiver. According to another aspect, in order to schedule an appointment, a service receiver can be required to make some pre-determined payment, for example, via a credit card or a debit card.

The present invention is directed to an Internet-based appointment scheduling system and, more particularly, to a system which allows the scheduling of appointments with one or more of a plurality of service providers from remote locations.

### BACKGROUND

Many service providers, such as doctors, dentists, veterinarians, electricians, mechanics, service stations, hair dressers, health clubs, spas, personal trainers, massage therapists, cable television companies, telephone companies, teachers, car services and golf courses, to name a few, typically make appointments with their patient/customers. Most often, in today's society, a patient or a customer wishing to make an appointment with a service provider will place a telephone call to the service provider where the service provider or an employee of the service provider will review a schedule of available appointments and compare schedules with the potential customer orally until an appointment time which is satisfactory to both the service provider and the patient/customer is determined. An appointment is then entered into the service provider's appointment schedule by the service provider's employee. While this system has worked for many years, it has several disadvantages. For example, the time spent on telephone calls could be better utilized by the service provider in actually providing services and, at a minimum, is expensive and potentially distracting to the service provider's personnel. Furthermore, when a patient/customer cancels an appointment or simply does not show up for a scheduled appointment, a service provider typically loses the income that would have been obtained by providing services to the scheduled customer during that time period and also loses the opportunity to schedule another person during that time slot.

Additionally, when a patient/customer calls for an appointment, they are limited to the information provided to them by the personnel of the service provider. Therefore, there is the risk of miscommunication and of the person scheduling appointments failing to mention an available time slot which might be best suited for the service receiver. With present scheduling practices, it is sometimes cumbersome for a service provider to make stand-by appointments which would be confirmed if an already booked appointment time slot becomes available. Therefore, it will be appreciated that there is room for much improvement with present appointment scheduling practices.

While appointment scheduling systems have been suggested in the past, those systems are typically designed for use by the service provider. For example, U.S. Pat. No. 5,848,395 to Edgar et al. discloses an appointment booking and scheduling system designed for maximizing the cost efficiency of service engineers visiting customer sites within a defined geographic area. The disclosed system is designed to optimize the routes of the service engineers visiting customer sites in order to optimize the cost efficiency of those traveling service engineers. According to that system, if a customer requests an appointment, a customer is offered an appointment within a pre-determined time slot. There is no provision that a customer is provided with the ability to review the entire appointment schedule of one or more service providers in order to readily schedule an appointment which is most convenient for the service receiver.

It would therefore be desirable to provide a system for scheduling appointments which displays schedules of at least one and preferably a plurality of service providers to the service receiver, e.g., a customer or patient. It would also be desirable to provide a remote appointment scheduling system which provides monetary protection to the service provider when customers do not show up for their scheduled appointments.

These and other advantages are provided with the appointment scheduling systems and methods described in greater detail below.

### SUMMARY OF THE INVENTION

The present invention comprises appointment scheduling systems and methods of providing service receivers with remote appointment scheduling capabilities utilizing the Internet and capable of providing a visual display. According to one embodiment of the present invention, a service provider, such as a physician, enters a schedule into a computer system which displays time slots in which the physician-will see patients. The physician can block out periods of time for which no appointments can be scheduled, for example, when the physician will be at a conference, when the physician has personal business, or on days in which the physician regularly performs surgery. The system advantageously provides the service provider with the ability to continually modify the appointment schedule in order to block out additional slots of time or to make time slots available. This system is linked to the Internet where it is available for viewing by the general public. When a member of the general public accesses the physician's scheduling system, the potential service receiver can view the entire schedule and make an appointment without further intervention from the physician. As used herein, the term “Internet” is used to indicate the publicly accessible worldwide web and to exclude “intranet” systems whose parameters are limited by access codes. The various aspects of the present invention can be practiced utilizing hardware that is part of an intranet system provided that this hardware has Internet access. The various embodiments of the present invention can utilize different types of hardware, software and/or firmware, as will be appreciated from the present description by one skilled in the art, and is therefore not set forth in greater detail herein. The preferred embodiments of the present invention are particularly useful for service providers who are typically visited by one or more service receivers.

According to another aspect of the present invention, the scheduling system maintains the schedule of the service-receiver as well, in order to minimize the chance for, and preferably prevent, the inadvertent scheduling of conflicting appointments by the service receiver. According to this preferred embodiment of the present invention, as the service receiver makes appointments with different service providers and/or adds other input to his/her own schedule, the service receiver's schedule is updated. Discernible signals, such as audible or visual alarms, can be provided to a service receiver or to a service provider if they attempt to schedule conflicting appointments.

According to a preferred embodiment of the present invention, in order to schedule an appointment, a service receiver must make some pre-determined payment, for example, via a credit card or a debit card, in order to make an appointment. Any form of acceptable payment can be used. Preferably, this deposit is applied to charges normally charged for the services received. However, if the service receiver does not show up for the appointment and does not comply with some, preferably predetermined, requirement, such as cancelling that appointment, some predetermined time period prior to the appointment, then all or a portion of the deposit can be retained by the service provider.

According to another preferred aspect of the present invention, the schedules of a plurality of service providers of one type of service are provided to a potential service receiver. According to this aspect of the invention, if one service provider does not have an appointment which is convenient for the service receiver, then the service receiver can readily view the availability of other providers of the same service.

The systems and methods of the present invention also preferably provide a service receiver with the ability to share his or her appointment schedule with others, in conjunction with one of the above aspects. For example, a person can check the schedule of their spouse and children while viewing the schedule of a service provider in order to determine potential conflict and/or the availability of all parties at a given time.

Another aspect of the present invention allows a potential service receiver to indicate a preference for a time slot which is already reserved and, if that time slot subsequently becomes available prior to the appointment, for example, due to a cancellation, the second service receiver is notified, preferably automatically, e.g., by e-mail.

The present invention also provides service providers with the ability to advertise and indicate multiple sites, and also provides links to related services such as to a web site which provides directions for the service receiver to the location of the service provider.

Preferred embodiments of the present invention comprise methods and/or apparatus wherein the service receivers visit one or more service providers.

### BRIEF DESCRIPTION OF THE DRAWINGS

FIGS. 1-11 illustrate eleven screen displays that can be displayed to a potential service receiver according to one embodiment of the present invention.

The present invention comprises Internet-based appointment scheduling systems and methods of providing service receivers with remote appointment scheduling capabilities for at least one and most preferably a plurality of service providers. According to one embodiment of the present invention, service providers input their appointment schedules into their own scheduling data file. The scheduling data file can be maintained on a personal computer, a network system, or on some other system capable of maintaining and updating a scheduling system, while permitting changes to the schedule and preferably permitting the visual displays of the system at any service provider's location and at remote locations when the system is accessed over the Internet. The service providers can view their own appointment schedules at any time and can change the appointment schedules in any way desired, for example, to block out days or sections of time when they are not available for appointments, to make additional appointments available, to change the duration of appointments, to customize the length of appointments for different services, etc. For example, if an auto servicing center hires an additional mechanic, the service center can expand its appointment schedule in order to make additional appointments available for the new mechanic. Preferably, when a service provider views its own appointment schedule, all information, such as the identity of the service receiver and the reason that certain times are blocked out, will be displayed. Additionally, one or more personal schedules of the service providers are displayed on the service providers schedule only, or in response to access codes input by specific service providers so that those service providers can readily avoid conflicts between their personal schedules and business obligations. Therefore, personnel at the service provider can advantageously view their own personal schedules and can see all information on the appointment schedule of the service provider. This information, is preferably not available to all potential service receivers.

When a service receiver accesses the schedule of a service provider, the service receiver can see which days and times the service provider typically provides appointments, as well as the duration of certain appointments depending upon the service to be provided, however, the service receiver will preferably not be able to determine the identity of service receivers already scheduled in reserved time slots. The service receiver is able to view only information which the service provider designates to be accessible.

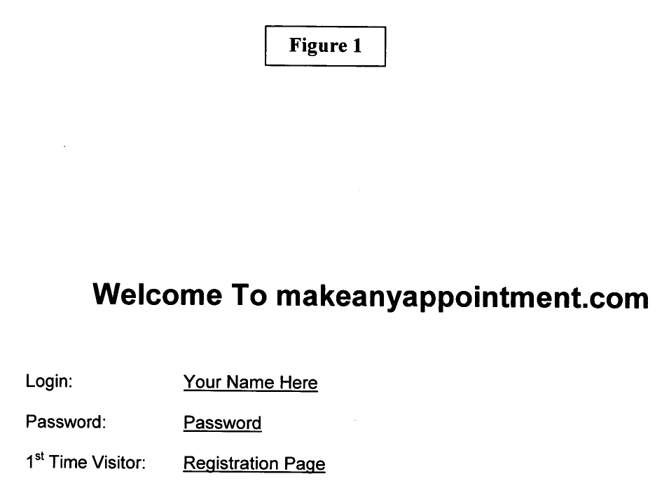

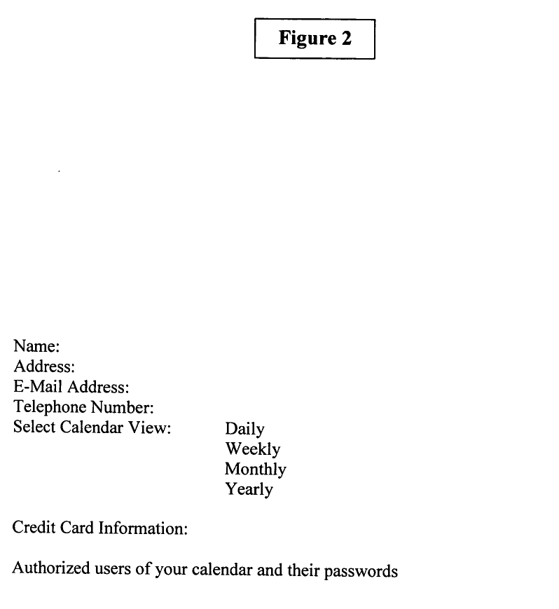

The Figures illustrate screen displays which can be provided to a potential service receiver in accordance with one embodiment of the present invention. In this illustrated embodiment, a web site having the address makeanyappointment.com is accessible from any Internet or web linked location. When a potential service receiver accesses the site, one possible display shown in FIG. 1 can be displayed and he can be required to provide some identifying information which can be automatically input from a stored file in his computer or can be input manually. Such information can include, for example, the persons name and password. If the service receiver is a first time user, he can be automatically sent to a registration page wherein he can be requested or required to input certain additional information. Such additional information can include, but is not limited to, billing address, e-mail address, telephone number, credit card information and the identity of authorized users of their scheduling systems along with those authorized persons passwords as indicated on FIG. 2. Since the preferred embodiment of the present invention permits system users including both service receivers and service providers to access the schedules of other users for whom they have that user's password, system users can compare schedules to avoid conflicts and send messages to other users. For example, a parent may wish to send a scheduling reminder to one of their offspring. Most preferably, the system automatically searches for scheduling conflicts with users designated as requesting non-conflicting schedules, i.e., “authorized users of your calendar and their passwords”. Preferably, if this is not a first time user, this information is automatically stored.

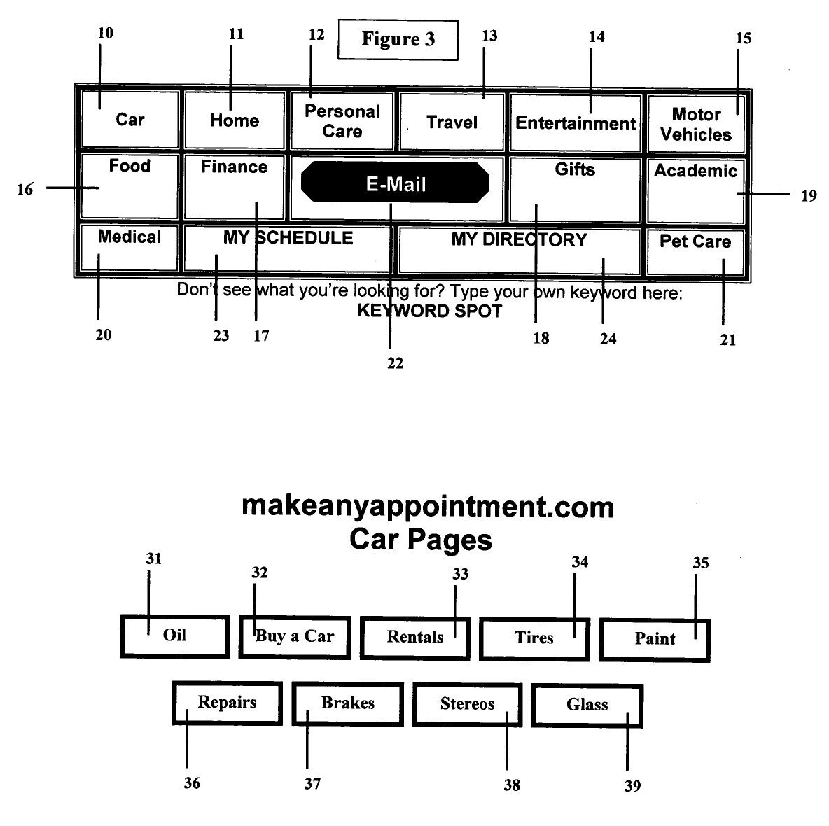

After the potential service receiver has input sufficient data, then a plurality of service providers will preferably appear on their screen. The initial display viewed by the service receiver can be specific to a specific service provider, can provide a plurality of service providers which are unrelated, can be from a certain geographic region, or can relate to a certain type of service. Alternatively, the service receiver can be provided with their own customized screen display comprising their own list of personal service providers such as doctors, mechanics, hair dressers, etc. In this illustrated embodiment, the service receiver is shown a screen display comprising clickable “links” which permits them to choose from a wide variety of commonly used service providers. The illustrated screen display in FIG. 3 comprises links for services relating to the following: link 10 labeled “CAR”, link 11 labeled “HOME”, link 12 labeled “PERSONAL CARE”, link 13 labeled “TRAVEL”, link 14 labeled “ENTERTAINMENT”, link 15 labeled “MOTOR VEHICLES”, link 16 labeled “FOOD”, link 17 labeled “FINANCE”, link 18 labeled “GIFTS”, link 19 labeled “ACADEMIC”, link 20 labeled “MEDICAL”, and link 21 labeled “PET CARE”. Additionally, a link labeled 22 is provided to the service receiver's “E-MAIL”, their own personal appointment schedule link 23 labeled “MY SCHEDULE” and a customized directory of service providers and/or other names and addresses entitled “MY DIRECTORY” link 24.

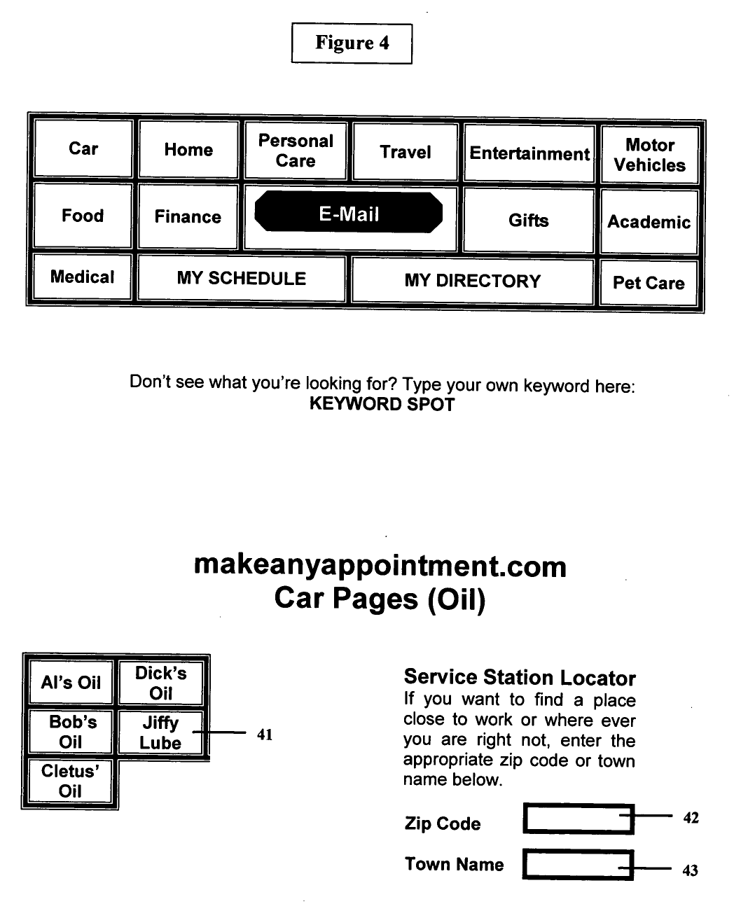

For illustration purposes, if the service receiver clicked on the CAR “link” then the screen shown in FIG. 3 is displayed. As illustrated in FIG. 3, this screen preferably continues to display the most commonly used service providers of this service receiver. Furthermore, in light of the click on the CAR link, additional links indicating specific service providers relating to cars are displayed. In this illustrated embodiment, a link 31 labeled “OIL” is displayed, a link 32 labeled “BUY A CAR” is displayed, link 33 labeled “RENTALS” is displayed, link 34 labeled “TIRES” is displayed, link 35 labeled “PAINT” is displayed, link 36 labeled “BODY REPAIRS” is displayed, link 37 labeled “BRAKES” is displayed, link 38 labeled “STEREOS” is displayed and link 39 labeled “GLASS” is displayed. Thus, from the present description and illustration it would be appreciated that the initial category indicated by link 10 for “CAR” brings up a display of related sub-categories for further input by the service receiver. For purposes of illustration, if the service receiver clicked on link 31 labeled “OIL” then the screen display indicated in FIG. 4 is displayed.

The display screen shown in FIG. 4 illustrates five service providers which each offer automotive oil changing services. Link 41 is prominently displayed and is the multi-site provider, Jiffy-Lube. The remaining service providers may be single or multiple site service providers and may also provide other services. In the event that the person making the appointment does not wish to use one of the pre-programmed service providers, they are also provided with the option of locating a similar service provider based upon geographic location. As indicated, the service receiver can input the zip code in screen portion 42 and/or town name in screen portion 43 of where he would like the service provided in order to gain access to schedules of service providers in that area.

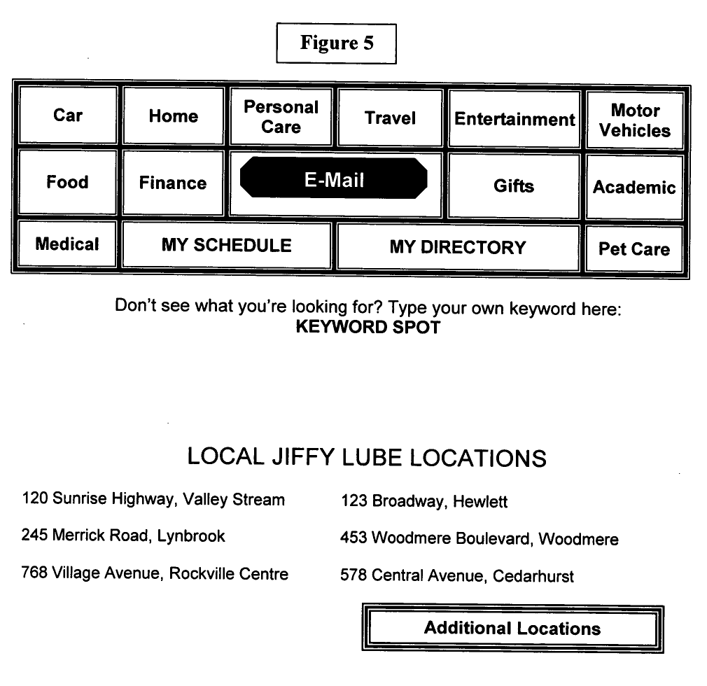

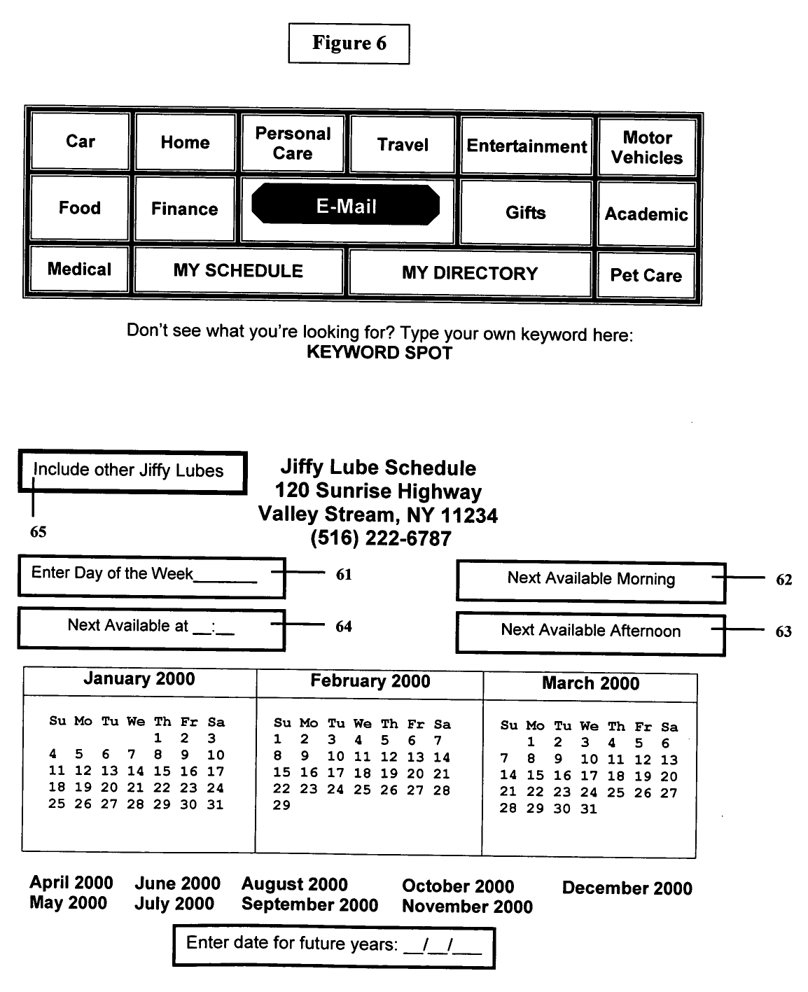

For purposes of illustration, it is assumed that the service receiver pushed JIFFY LUBE link 41 and was then shown the display screen illustrated in FIG. 5. In the display screen of FIG. 5, the service receiver can click on the location most convenient or can request additional locations. For purposes of this illustration, it is assumed that the service receiver clicked on the first link listing a Jiffy Lube in Valley Stream and is then provided with the display shown in FIG. 6.

The person making the appointment is provided with many options with the screen shown on FIG. 6. This display screen provides the customer with the ability to view only appointments during specific days of the week by clicking on link 61 and then clicking on the specific day of the week in a display (not shown). Alternatively, by clicking on box 62, the customer can immediately see the next available morning appointment or by clicking on box 63, the customer can see the next afternoon appointment. Box 64 allows a service receiver to input a specific time slot, e.g., 3:30 p.m., to find the next available appointment during that specific time. Box 65 permits the customer to expand the scope of his search to include other service providers, such as other Jiffy Lubes when searching for an appointment at a specific time or day of the week. Display 66 also provides the user with calendars for some predetermined period of time, preferably starting with the day that the appointment schedule is being displayed. Therefore, for purposes of this display, it is assumed that the display is being viewed on Jan. 1, 2000. In addition to the display calendar showing each day for the months of January, February and March, 2000, this display also provides the customer with the ability to go to future months.

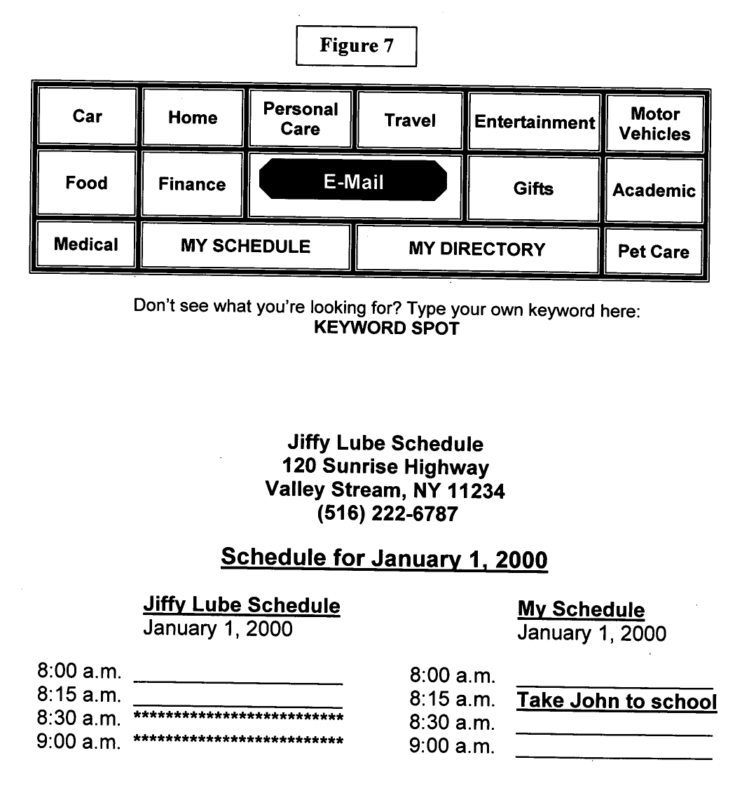

For purposes of this illustration, the user clicked on Jan. 1, 2000 and is then displayed the screen shown in FIG. 7. For convenience, the next display also indicates the service receiver's personal schedule in juxtaposition with the available schedule from Jiffy Lube for that particular day. It is also within the scope of the present invention to simply provide the schedule of the service provider without that of the service receiver. The system can also be provided with controls for rejecting a conflicting schedule and indicating to any system user that a conflict exists if the user already has something scheduled during that time period. Discernible indicia such as a display or an audible alarm will be provided to a service receiver if the service receiver attempts to schedule an appointment which conflicts with an already existing appointment or scheduled obligation of the service receiver. For example, in the display illustrated in FIG. 7, the scheduling of an 8:00 a.m. appointment at the Valley Stream Jiffy Lube which could extend from 8:00 a.m. until 8:30 a.m. could conflict with the service receiver's 8:15 a.m. obligation to “take Johnny to school”. While this illustrated embodiment shows the use of a conflict indicator for a service receiver, it is also within the scope of the present invention to provide a discernible indicia of a conflict to a service provider when the service provider uses a system of the present invention to coordinate the service provider's business schedule and personal schedule.

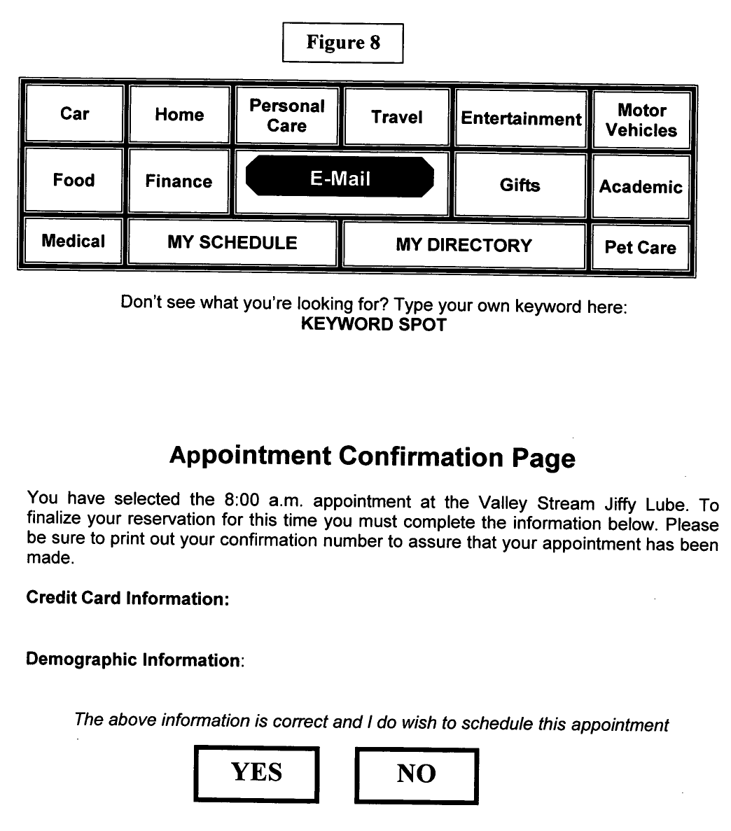

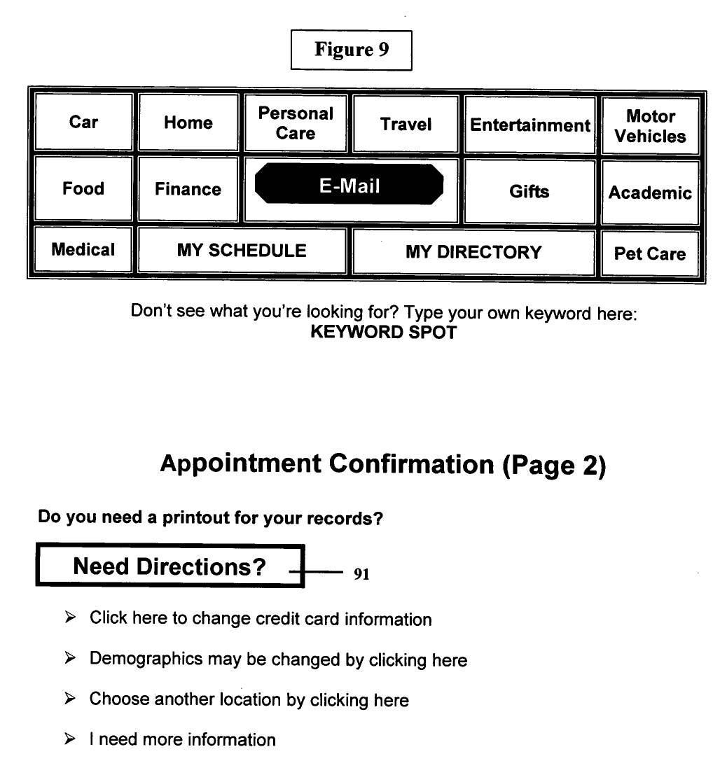

When the customer indicates that he/she wants the 8:00 a.m. appointment, the customer is shown the display screen shown in FIG. 8. The screen shown in FIG. 8 is a confirmation screen which preferably automatically lists the service receiver's credit card information and indicates the rules required for finalization of the appointment as well as the amount of credit card deposit amount required, the amount of advanced notice required for cancellation without charge, as well as any other notices, such as stand by appointments that the service receiver made. In order to confirm the information and acceptance of the appointment, the service receiver must click on the “YES” link according to this illustrated embodiment of the present invention. For purposes of illustration, it is assumed that the receiver clicked on the “YES” link. The service provider's schedule and preferably, the service receiver's schedule, are preferably updated. The service receiver is then displayed in the screen shown in FIG. 9 wherein he is provided with the option of obtaining directions. The link 91 labeled “NEED DIRECTIONS?” can be linked to another website such as mapquest.com. Alternatively, this system can have its own built-in map generator which provides the service receiver with directions or a map upon request.

If the service receiver had clicked “NO” on the confirmation screen shown in FIG. 8, the service receiver is preferably provided with the opportunity to change some or all of the information shown in the screen of FIG. 8. After any desired information is modified, for example, the input of different credit card information, then the service receiver is again provided with the confirmation screen of FIG. 8 with the modifications displayed.

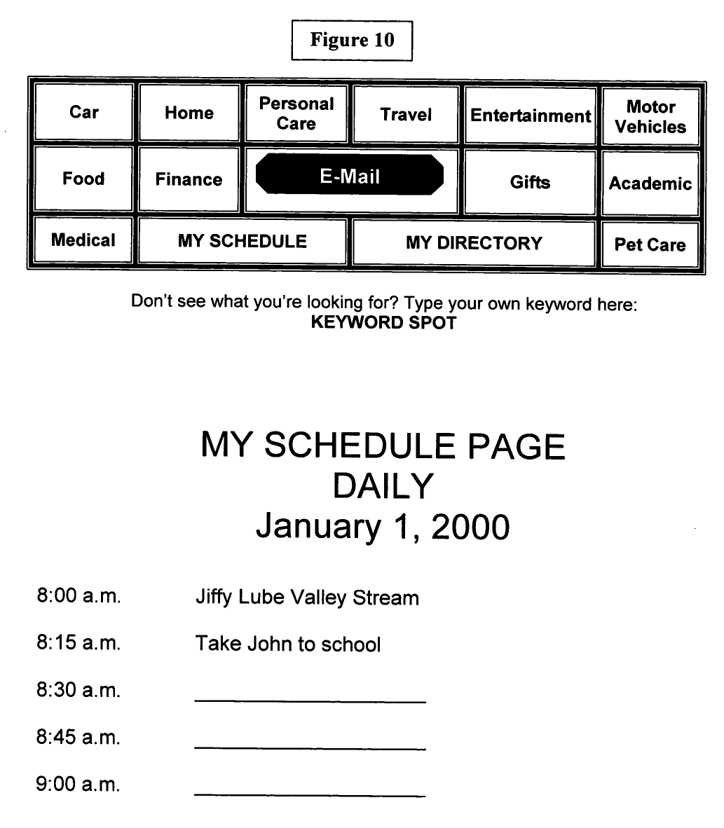

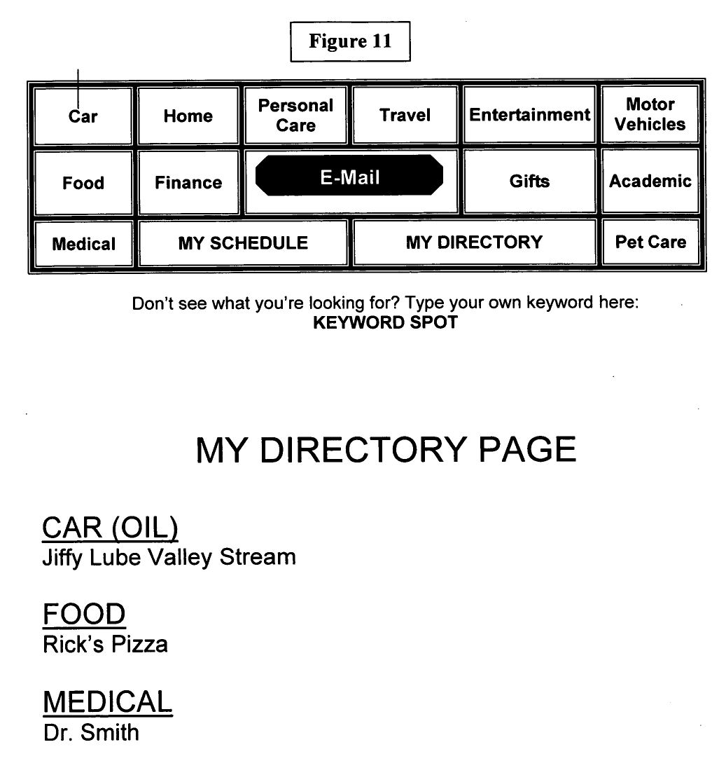

FIGS. 10 and 11 show examples of a user's personal schedule and personal directory, respectively.

Therefore, it will be appreciated that according to certain aspects of the present invention, scheduling systems are provided wherein service receivers can schedule their own appointments with service providers from remote locations. The scheduling systems and methods of the present invention advantageously provide the capability of making appointments with either related or unrelated businesses utilizing the disclosed scheduling systems. As used herein, the term “related business” is used to indicate that the businesses are commonly owned, are part of a single franchise, or that they have some common ownership. The systems and methods also comprise the ability to require payment for scheduling an appointment. Payment is secured by receiving payment information, typically in the form of credit card information. As the term “credit card information” is used herein, it is meant to include any form of electronic payment including providing a credit card number, expiration date, name of card holder, debit card information, electronic wire transfer of funds, etc.

The precise form of the electronic or computer hardware, software or firmware which is utilized to perform the functions described herein can take different forms, is within the level of skill of one of ordinary skill in the art and is therefore not explained in further detail herein.

One preferred aspect of the present invention comprises an Internet-based appointment scheduling system for at least one, and preferably a plurality of service providers comprising a personal computer, comprising a keyboard, display screen and CPU and suitable hardware and connections for allowing a service provider to input a business appointment schedule and preferably a personal appointment schedule. The service provider's appointment schedule can also be maintained on a local area network or some other system which is accessible by service receivers over the Internet. Service receivers then can access the business appointment schedule of the service provider, or at least those portions of the service provider's appointment schedule that the service provider wishes to make accessible, from any remote computer or other device capable of Internet access. Preferably, from a service receiver's home, the service receiver will access the business appointment schedule of the service provider and select a convenient appointment. Preferably, when a service receiver confirms an appointment, the service provider's schedule of available appointments is simultaneously updated to indicate that another appointment slot has been taken.

The system to which the service provider's schedule is input can be located at the service provider's place of business or at some other central location which will therefore coordinate the business and/or personal schedules of a plurality of service providers from related or unrelated businesses and similar or different types of service providers.

According to one preferred aspect of the present invention, when a service receiver schedules an appointment, the system requires receipt of payment information such as credit card information, prior to confirming the appointment. Another preferred aspect of the present invention allows a service receiver to make a stand-by appointment for appointment time periods which are already reserved by another service receiver. If that appointment time subsequently becomes available, the service receiver is preferably notified. Additionally, if that time slot is determined to be no longer available by the service provider or for some other reason, the service receiver who made a stand-by appointment can be notified.

While the illustrated embodiment of the present invention provides information and links to unrelated service providers, the present invention can be utilized by a single service provider which wishes to provide its service receivers, e.g., customers or patients, with Internet appointment schedule capabilities. If the present systems are utilized to their fullest capability by many users, then schedule conflicts can readily be avoided since conflicting schedules will not be permitted, but will be indicated by some sort of visible or audible alarm.

Other aspects of the present invention comprise methods of providing a plurality of service receivers with remote appointment scheduling capabilities for at least one common service provider, preferably a plurality of service providers, over the Internet. One method of the present invention comprises providing a system for inputting and displaying at least one appointment schedule of at least one service provider at a first location. The inputting and displaying system can comprise a computer as stated above. According to this method, the service provider inputs his business appointment schedule and then service receivers at distant locations, such as their homes, can access and display the service provider's schedule on their home computers or other Internet accessible device. Upon viewing the service provider's schedule, the service receivers can make appointments during open time slots and, most preferably, can also make stand-by appointments for already reserved time slots. The displays accessed by both the service providers and service receivers are updated continuously as appointments are made and changed. Service receivers are preferably required to make some form of monetary payment, for example, using a credit card or by providing information. That payment is preferably refundable or creditable toward another service if the service receiver either cancels or provides notice of the cancellation or changes the appointment automatically over the Internet using the service provider's computer or other input device within prescribed times. The scheduling system also preferably updates the service receiver's personal schedule immediately as an appointment is confirmed. The scheduling system can actually comprise separate software wherein a service receiver's schedule is maintained on the service receiver's personal computer at home or the service receiver's schedule can be maintained on a larger centralized system which is accessed upon demand by the service receiver, for example, by use of a password. Similarly, the schedules of one or more-service providers can be maintained either on software and computing hardware at their place of business or at some other centralized location. As noted above, the service providers can comprise a number of service providers in the same actual company located at a single or multiple locations. Alternatively, a number of service providers from unrelated businesses which are either of different types of business or of the same type of business can be displayed to one or more service receivers.

1. An internet-based appointment scheduling system for at
least one service provider comprising:
means for inputting a business appointment schedule of at least one service provider at a first location;
means for transmitting at least a portion of said service provider's updated business appointment schedule over the Internet to service receivers at a plurality of locations remote from said first location, where said appointment schedule is visually displayed to the service receivers;
means for receiving input from said service receivers at said plurality of remote locations to schedule appointments with said service provider; and
means for updating said service provider's business appointment schedule.

2. An Internet-based appointment scheduling system according to claim 1 wherein said inputting means comprises means for visually displaying said service provider's schedule.

3. An Internet-based appointment scheduling system according to claim 1 comprising a plurality of means for inputting appointment schedules of a plurality of service providers at a plurality of remote locations.

4. An Internet-based appointment scheduling system according to claim 3 wherein at least some of said plurality of service providers are unrelated businesses.

5. An Internet-based appointment scheduling system according to claim 3 wherein at least some of said plurality of service providers are related business.

6. An Internet-based appointment scheduling system according to claim 5 wherein at least some of said plurality of service providers are unrelated business.

7. An Internet-based appointment scheduling system according to claim 4 wherein at least some of said plurality of service providers provide the same type of service.

8. An Internet-based appointment scheduling system according to claim 1 wherein said input receiving means comprises means for receiving payment information.

9. An Internet-based appointment scheduling system according to claim 8 wherein said payment information comprises credit card information.

10. An Internet-based appointment scheduling system according to claim 8 wherein said payment information comprises information other than credit card information.

11. An Internet-based appointment scheduling system according to claim 1 wherein said input receiving means further comprises means for receiving requests for stand-by appointments for appointment times which are already reserved.

12. An Internet-based appointment scheduling system according to claim 11 further comprising means for notifying any service receiver who requested said already reserved appointment time, if said appointment becomes available.

13. An Internet-based appointment scheduling system according to claim 11 further comprising means for informing service receivers that stand-by times are no longer available.

14. An Internet-based appointment scheduling system according to claim 1 further comprising links to websites unrelated to said service provider.

15. An Internet-based appointment scheduling system according to claim 14 further comprising links to other websites which provide directions to the service provider's location.

16. An Internet-based appointment scheduling system according to claim 1 wherein said system also comprises means for receiving input of at least one service receiver's schedule and displaying said service receiver's schedule to said service receiver.

17. An Internet-based appointment scheduling system according to claim 16 further comprising discernible indicia of a schedule conflict which is provided to a service receiver if said service receiver inputs an appointment with a service provider which would conflict with the service receiver's schedule.

18. An Internet-based appointment scheduling system according to claim 17 wherein said discernible indicia comprises a visible display.

19. An Internet-based appointment scheduling system according to claim 17 wherein said discernible indicia comprises an audible signal.

20. An Internet-based appointment scheduling system according to claim 16 further comprising indicia of a schedule conflict which is provided to a service receiver if said service receiver inputs an appointment with a service provider which would conflict with the schedule of a person other than said service receiver.

21. An Internet-based appointment scheduling system according to claim 1 wherein said inputting means also receives and updates a service provider's personal schedule.

22. An Internet-based appointment scheduling system according to claim 21 further comprising indicia of a schedule conflict if a service provider inputs a business schedule which may conflict with said service provider's personal schedule.

23. An Internet-based appointment scheduling system according to claim 16 wherein a plurality of service receivers have coded access to each other's schedules.

24. An Internet-based appointment scheduling system according to claim 1 wherein said input receiving means receives scheduling input from a plurality of service providers and a service receiver is provided with the ability to schedule an appointment with at least one of said plurality of service providers.

25. A method of providing a plurality of service receivers with remote appointment scheduling capabilities for at least one service provider over the Internet comprising the steps of:
providing means for inputting and displaying at least one appointment schedule of at least one service provider at a first location;
inputting at least a portion of a service provider's business appointment schedule into said inputting and displaying means, said portion comprising open time slots;
providing access to a visual display of at least a portion of said service provider's appointment schedule at a plurality of remote locations to a plurality of service receivers, wherein said displays comprise time periods for which appointments have not yet been scheduled;
providing said service receivers with the ability to schedule appointments during said open time slots from said remote locations by providing input to schedule appointments with said service provider and thereby changing said service provider's schedule of available appointments;
wherein said step of displaying said appointment schedule comprises providing updated displays.

26. A method of providing a plurality of service receivers with remote appointment scheduling capabilities according to claim 25 wherein said inputting and displaying means comprises a computer.

27. A method of providing a plurality of service receivers with remote appointment scheduling capabilities according to claim 25 wherein said service receivers provide input through a computer to schedule appointments over the Internet.

28. A method of providing a plurality of service receivers with remote appointment scheduling capabilities according to claim 25 wherein said step of receiving input from said service receiver also changes said service receiver's schedule.

29. A method of providing a plurality of service providers with remote appointment scheduling capabilities according to claim 25 further comprising the step of inputting at least a portion of a service provider's personal schedule.

30. A method of providing a plurality of service providers with remote appointment scheduling capabilities according to claim 29 wherein said service provider's personal schedule is not displayed at said remote locations.

31. A method of providing a plurality of service providers with remote appointment scheduling capabilities according to claim 25 wherein a plurality of service providers schedules are input into said inputting and displaying means.

32. A method of providing a plurality of service providers with remote appointment scheduling capabilities according to claim 31 wherein at least portions of said service providers' schedules are displayed at said remote locations.

33. A method of providing a plurality of service providers with remote appointment scheduling capabilities according to claim 31 wherein said service providers are located at a single business location.

34. A method of providing a plurality of service providers with remote appointment scheduling capabilities according to claim 34 wherein said service providers are from unrelated businesses.

35. A method of providing a plurality of service providers with remote appointment scheduling capabilities according to claim 34 wherein said service providers are from the same type of business.

36. A method of providing a plurality of service providers with remote appointment scheduling capabilities according to claim 31 wherein said service providers are from related businesses.

37. A method of providing a plurality of service providers with remote appointment scheduling capabilities according to claim 25 further comprising the step of requiring some form of payment from a service receiver when a service receiver schedules an appointment with a service provider.

38. A method of providing a plurality of service providers with remote appointment scheduling capabilities according to claim 37 further comprising the step of verifying a payment from a service receiver.

39. A method of providing a plurality of service providers with remote appointment scheduling capabilities according to claim 25 further comprising the step of providing service receivers with the ability to schedule stand-by appointments for appointment periods which are already reserved.

40. A method of providing a plurality of service receivers with remote appointment scheduling capabilities according to claim 39 further comprising the step of providing service receivers with a message if said previously reserved appointment period becomes available.

41. A method of providing a plurality of service receivers with remote appointment scheduling capabilities according to claim 25 further comprising providing service receivers links to websites unrelated to said service providers.

42. A method of providing a plurality of service receivers with remote appointment scheduling capabilities according to claim 25 further comprising the step of providing a discernible indication if a service receiver attempts to schedule a conflicting appointment.

43. A method of providing a plurality of service providers with remote appointment scheduling capabilities according to claim 25 further comprising the step of providing a discernible indication if a service provider attempts to schedule a conflicting appointment.

44. A method of providing a plurality of service providers with remote appointment scheduling capabilities according to claim 25 further comprising inputting a schedule for a person other than said service receiver.
